(19) United States
(12) Patent Application Publication
(10) Pub. No.: US 2001/0042253 A1
(43) Pub. Date: Nov. 15, 2001

(54) Multimedia service system using virtual server

(76) Inventor: Byung Dal Jung, Anyang (KR)

Correspondence Address: BIRCH, STEWART, KOLASCH & BIRCH, LLP, P. O. Box 747, Falls Church, VA, 22040-0747, US

(21) Appl. No.: 09/750,346

(22) Filed: Dec. 29, 2000

(30) Foreign Application Priority Data
Dec. 31, 1999 (KR) 68079/1999

(51) Int. Cl. G06F 15/16; H04N 7/173

(52) U.S. Cl. 725/91; 725/114; 709/219

(57) ABSTRACT

A multimedia service system using a virtual server including: clients for requesting information and receiving information corresponding to the request; a server for providing the corresponding information according to the request by the clients; and a virtual server being connected with the clients via a first network to receive the request on information from the clients and transmit it to the server, and being connected with the server via a second network to receive and store the information provided from the server, control a traffic of the networks and transmit the information suitable to the characteristics of the clients. The multimedia service system using the virtual server is adaptable to the traffic of the network regardless of the number of the clients which request multimedia, so that a corresponding multimedia can be provided to the clients effectively.

### BACKGROUND OF THE INVENTION

1. Field of the Invention

The present invention relates to a system for providing a multimedia, and more particularly, to a multimedia service system using a virtual server which is capable of controlling a traffic on a real time basis according to the state of the Internet, thereby effectively providing information.

2. Description of the Background Art

In the recently developed VOD (Video on Demand) multimedia service system through the Internet, as a client (a user) requests a desired multimedia from a server (an information provider), the server provides the multimedia to the client through the Internet. The VOD multimedia service system is adopted for use to various fields, such as a home-shopping, a remote education, an MOD (Music on Demand) or an NOD (News on Demand).

FIG. 1 illustrates a construction of a VOD multimedia service system in accordance with a conventional art.

As shown in the drawing, the VOD multimedia service system includes a server 1 for providing information and a plurality of clients 3-1, 3-2, . . . , 3-m connected with the server 1 via a communication network 2.

In the system, when the clients requests a multimedia from the server, the server equally provides the corresponding multimedia to all of the clients requesting it. In other words, the server equally provides the corresponding multimedia to the clients who request the multimedia on a real time basis, without controlling a traffic of the Internet which connects the server and the clients.

Thus, due to the inability of the VOD multimedia service system to detect or control a traffic of the Internet, when the traffic is changed, a time required for providing the multimedia from the server of the multimedia system to the clients is lengthened and the quality of the multimedia is degraded.

### SUMMARY OF THE INVENTION

Therefore, an object of the present invention is to provide a multimedia service system using a virtual server in which a traffic of a network is controlled to provide high-quality information from a server to a client on a real time basis.

To achieve these and other advantages and in accordance with the purpose of the present invention, as embodied and broadly described herein, there is provided a multimedia service system using a virtual server including: clients for requesting information and receiving information corresponding to the request; a server for providing the corresponding information according to the request by the clients; and a virtual server being connected with the clients via a first network to receive the request on information from the clients and transmit it to the server, and being connected with the server via a second network to receive and store the information provided from the server, control a traffic of the networks and transmit the information suitable to the characteristics of the clients.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a VOD multimedia service system using the Internet in accordance with a conventional art;

FIG. 2 shows a construction of a VOD multimedia service system in accordance with the present invention;

FIG. 3 shows a construction for explaining a method in which a multimedia service system using a virtual server transmits multimedia to clients that accesses thereto at different time to each other in accordance with the present invention;

FIG. 4 shows a construction for explaining a method for controlling a transfer rate of a multimedia data of the multimedia service system using a virtual server in accordance with the present invention;

FIG. 5 shows a construction for explaining a method for managing a main memory and an auxiliary memory of the multimedia service system using a virtual server in case that a traffic delay takes place in an access network in accordance with the present invention; and

FIG. 6 shows a construction for explaining a method for controlling a traffic in a virtual server of the multimedia service system using the virtual server in accordance with the present invention.

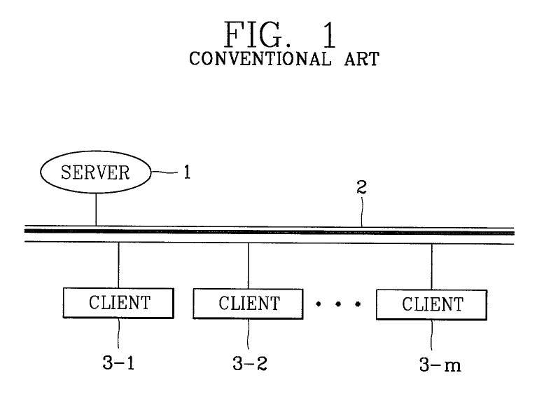

### DETAILED DESCRIPTION OF THE PREFERRED EMBODIMENTS

Reference will now be made in detail to the preferred embodiments of the present invention, examples of which are illustrated in the accompanying drawings.

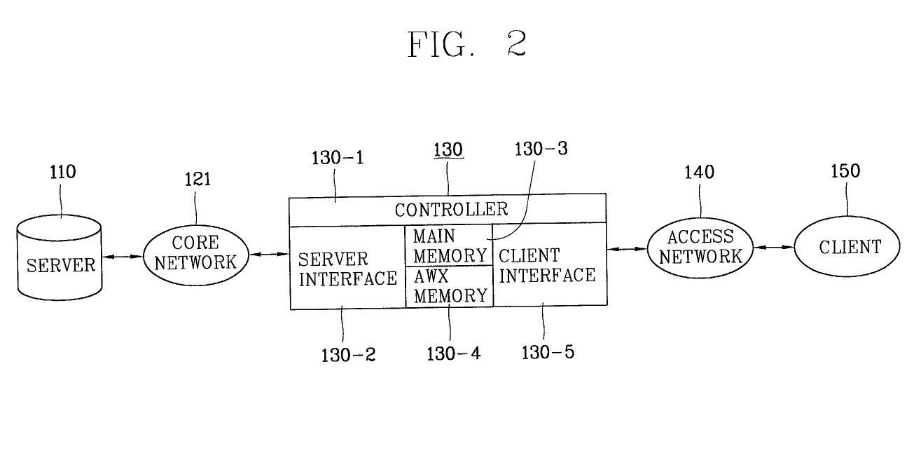

FIG. 2 shows a construction of a VOD multimedia service system in accordance with the present invention.

As shown in the drawing, the VOD multimedia service system of the present invention includes a server 110 storing and providing information such as a multimedia; a client 150 for requesting and being provided with information; and a virtual server 130 for transmitting the request of the client 150 to the server 110, pre-fetching a predetermined data from the server 110 and storing it, and providing the client with the requested information suitable to a reproduction speed of the client.

The server 110 and the virtual server 130 are connected by a core network 120, and the virtual server 130 and the client 150 are connected by an access network 140.

The virtual server 130 includes a controller 130-1 for detecting a traffic between the server 110 and the client 150 and controlling a system, a server interface unit 130-2 connected with the server 110 via the core network 120 for receiving and transmitting a signal from and to the server under the control of the controller 130-1, a main memory 130-3 and an auxiliary memory 130-4 for storing multimedia transmitted from the server 110, and a client interface unit 130-5 connected with the client 150 via the access network 140, for receiving and transmitting from and to the client under the control of the controller 130-1.

Notably, the data transfer rate of the core network 120 is much faster than a data transfer rate of the access network 140. Thus, the virtual server, installed to reduce the difference between the data transfer rate of networks, uses a protocol which is able to control a traffic of the access network so as to transmit the multimedia received and stored from the server to the client on a real time basis.

The operation of the VOD multimedia service system using a virtual server constructed as described above will now be explained.

When the client requests a multimedia from the server 110 through the access network, the virtual server 130 receives the request and transmits it to the server through the core network 120.

When the server outputs a corresponding multimedia according to the request of the virtual server, the main memory of the virtual server stores the multimedia through the core network and the server interface unit connected with the core network under the control of the controller.

Under the control of the controller, the multimedia stored in the main memory is transmitted to the client, fitting the display speed of the client, through the client interface and the access network connected with the client, and at the same time, stored in the auxiliary memory.

The controller manages the information of the server and of the client and the multimedia session, and controls the main memory and the auxiliary memory and the transmission between the main memory and the auxiliary memory.

The auxiliary memory of the virtual server stores all multimedia requested by clients, so that when a client requests a multimedia, which is already stored in the auxiliary memory, the auxiliary memory does not need to receive the same multimedia requested by the client from the server.

Accordingly, since the controller manages information of a client and the auxiliary memory of the virtual server stores the multimedia, the client may have a reduced size of buffer. The multimedia requested suitable to the multimedia display speed of the client is received by the virtual server, decoded and then displayed.

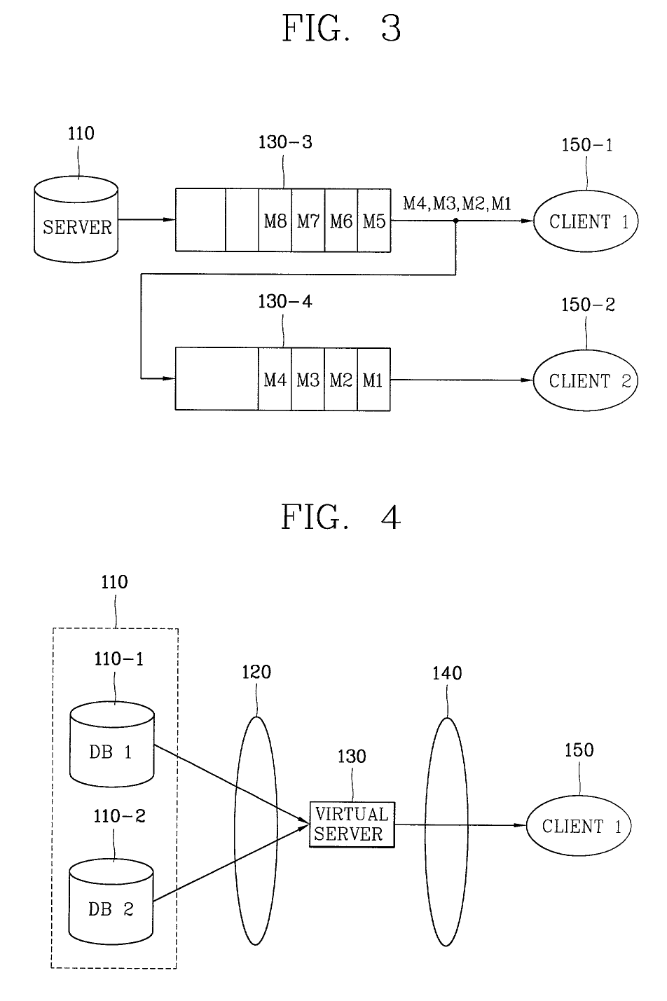

FIG. 3 shows a construction for explaining a method in which a multimedia service system using a virtual server transmits multimedia to clients that accesses thereto at different time to each other in accordance with the present invention.

As aforementioned, when the client 150-1 requests a multimedia, the virtual server 130 receives the multimedia M1, M2, M3 and M4 from the server 110 and stores it in the main memory 103-3. And then, the virtual server 130 transmits the multimedia to the client 150-1 and at the same time stores it in the auxiliary memory 130-4.

At this time, in case that a different client 150-2 requests the same multimedia as the multimedia that has been requested by the client 150-1, the virtual server transmits the multimedia corresponding to the request of the different client from the auxiliary memory 130-4 to the client 150-2.

Therefore, in the multimedia service system using the virtual server of the present invention, in case that a multimedia requested by a new client is the same multimedia that has been previously requested by a different client, the virtual server transmits the same multimedia that has been requested, from the auxiliary memory to the corresponding client, so that the load of the server which stores and provides a variety of information can be reduced.

FIG. 4 shows a construction for explaining a method for controlling a transfer rate of a multimedia data of the multimedia service system using a virtual server in accordance with the present invention.

As stated above, the data transfer rate of the access network 140 and the data transfer rate of the core network 120 are different to each other, the virtual server 130 uses the protocol adopted in the access network between itself and the client to sense a traffic of the access network. According to the traffic, the virtual server 130 receives a multimedia having the same multimedia content but different size from the multimedia data base (DB1 and DB2) 110-1 and 110-2 and transmits it to the client 150.

In this respect, in case that the traffic of the access network is not delayed, the data base DB1 110-1 stores a multimedia of a full size transmitted to the client through the virtual server. Meanwhile, in case that the traffic of the access network is delayed, the data base DV2 110-2 extracts and stores the critical part of the multimedia stored in the data base DB1 100-1, to be transmitted to the client through the virtual server. The critical part of the multimedia may be a data of which ‘B’ picture is reduced or a data of which ‘B’ and ‘P’ picture are reduced in a multimedia of an MPEG form.

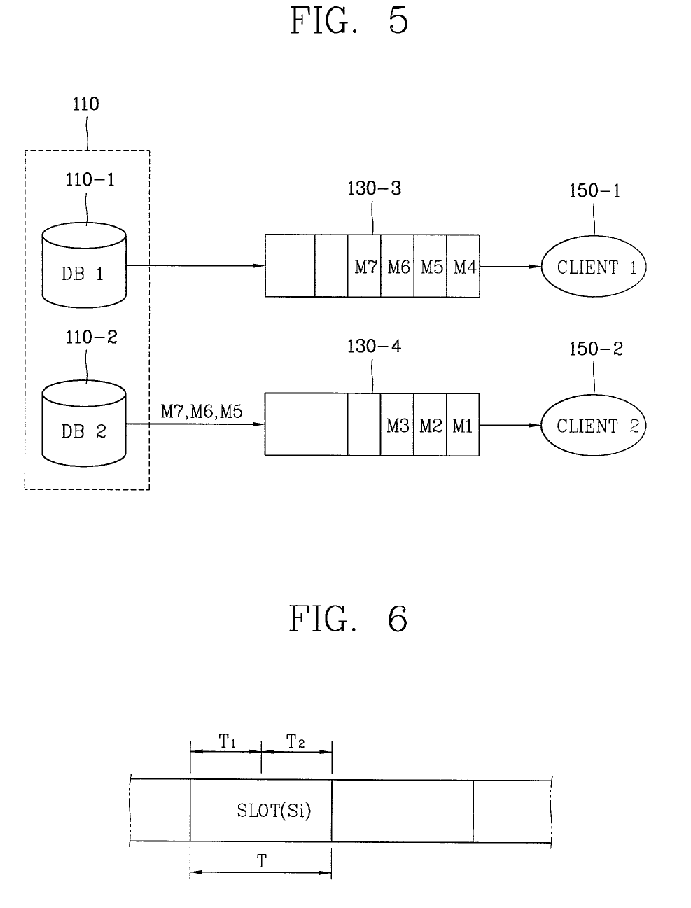

FIG. 5 shows a construction for explaining a method for managing a main memory and an auxiliary memory of the multimedia service system using a virtual server in case that a traffic delay takes place in an access network in accordance with the present invention.

First, the virtual server 130 receives both the multimedia from the data base DV1 110-1 of the server storing the full-size of multimedia and the multimedia from the data base DB2 110-2 of the server storing the critical part extracted from the multimedia of the same content and stores them in the main memory and the auxiliary memory. In this state, when the client 150-1 requests a multimedia, the virtual server provides the corresponding client 150-1 with the full-size of the multimedia.

At this time, in case that the virtual server which detects the traffic of the access network judges that there occurs a traffic delay, the virtual server requests and receives the critical part extracted from the multimedia from the data base DB2 130-2 of the server, rather than requesting the full size of the multimedia from the data base DB1 130-1, and then transmits the critical part of the multimedia to the corresponding client 150-2.

Accordingly, the multimedia service system using the virtual server in accordance with the present invention is adaptive to the traffic of the network, providing effectively the client with the multimedia.

FIG. 6 shows a construction for explaining a method for controlling a traffic in a virtual server of the multimedia service system using the virtual server in accordance with the present invention.

As shown in the drawing, a time T1 represents a time taken for transmitting a data from the server to the virtual server, a time T2 represents a time taken for transmitting a data from the virtual server to the client, and a time ‘T’ represents a time taken for transmitting a slot ‘Si’ of a predetermined size to the client.

Since there is a difference between the data transfer rate of the core network and the data transfer rate of the access network, the virtual server is installed to reduce the transfer rate difference. That is, the virtual server buffers a slot transfer scheduling and the slot ‘Si’ in the main memory and the auxiliary memory, to control the traffic so that the slot is transmitted from the server to the client within the time adding the time T1 and the time T2. In this respect, in case that transfer time of the slot ‘Si’ is granter than the addition of the time during which the virtual server receives the data and the time during which the virtual server transmits the data (that is, T>T1+T2), the virtual server fetches the data from the server as long as the difference time [T′=T−(T1+T2)], thereby effectively controlling the traffic of the network.

As so far described, the multimedia service system using the virtual server of the present invention is adaptable to the traffic of the network regardless of the number of the clients which request multimedia as well as controlling the traffic of the network, so that a corresponding multimedia can be provided to the clients effectively.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A multimedia service system using a virtual server comprising:
clients for requesting information and receiving information corresponding to the request;
a server for providing the corresponding information according to the request by the clients; and
a virtual server being connected with the clients via a first network to receive the request on information from the clients and transmit it to the server, and being connected with the server via a second network to receive and store the information provided from the server, control a traffic of the networks and transmit the information suitable to the characteristics of the clients.

2. The multimedia service system according to claim 1, wherein the server comprising:
a first data base for storing a full size of information; and
a second data base for storing a critical part extracted from the full size of the information stored in the first data base.

3. The multimedia service system according to claim 2, wherein the virtual server transmits the full size of information to the clients or a critical part extracted from the information to the clients.

4. The multimedia service system according to claim 2, wherein the information includes a multimedia of an MPEG form.

5. The multimedia service system according to claim 4, wherein the information stored in the second data base includes a multimedia having a small number of ‘B’ picture or having a small number of ‘B’ picture and ‘P’ picture.

6. The multimedia service system according to claim 1, wherein the virtual server reduces a data transfer rate difference between a first data transfer rate of a first network connected between itself and the server and a second data transfer rate of a second network connected between itself and the client.

7. The multimedia service system according to claim 6, wherein the first data transfer rate is faster than the second data transfer rate.

8. The multimedia service system according to claim 1, wherein the virtual server comprising:
a main memory for storing information received from the server;
an auxiliary memory for storing information outputted from the main memory; and
a controller for managing specifications of the server and the clients and information session outputted from the server, and controlling the main memory and the auxiliary memory and information transmitted between the main memory and the auxiliary memory.

9. The multimedia service system according to claim 8, further comprising:
a first interface unit connected with the first network; and
a second interface unit connected with the second network.

10. The multimedia service system according to claim 8, wherein the server comprising:
a first data base for storing a full size of information; and
a second data base for storing a critical part extracted from the full size of information stored in the first data base.

11. The multimedia service system according to claim 8, wherein in a state that information is stored in the auxiliary memory as having been requested by a previous client, in case that a different client requests the same information as previously stored one, the virtual server transmits the same information from the auxiliary memory to the different client.

12. The multimedia service system according to claim 10, wherein, under the control of the controller, the main memory receives and stores the full size of information and transmits it to the client, and at the same time, outputs it to the auxiliary memory.

13. The multimedia service system according to claim 10, wherein, under the control of the controller, the auxiliary memory stores information outputted from the main memory or receives and stores the critical part extracted from the information, and transmits it to the client.

14. The multimedia service system according to claim 1, wherein the characteristics of clients includes a reproduction speed of the clients.
